(19) United States
(12) Patent Application Publication
(10) Pub. No.: US 2012/0317971 A1
(43) Pub. Date: Dec. 20, 2012

(54) THERMAL PENDULAR ENGINE

(76) Inventor: John Warner JARMAN, (US)

(21) Appl. No.: 13/160,861

(22) Filed: Jun. 15, 2011

(51) Int. Cl. F02G 1/053

(52) U.S. Cl. 60/519

(57) ABSTRACT

The engine consists of two sealed containers joined by a near horizontally orientated pipe mounted at a point along its length upon a shaft assembly within which is housed an axle about which the device is free to oscillate, and so constructed as to interact with an attuned complementary pendulum. When a temperature differential exists between the two containers, either by means of heating one container (hot leg) and/or cooling the other (cold leg), the consequent increase in pressure in the hot leg forces a quantity of the encased working fluid along the pipe to the cold leg, thereby creating a weight imbalance and changing the device's planar orientation. This change in orientation allows gas to escape from the hot leg, and a cycle is subsequently developed in which liquid is alternately expelled from the hot leg and then readmitted as the device oscillates. Force from this oscillation is transmitted to the pendulum which begins to oscillate at its natural frequency in synchronous interaction with the device. The momentum attained by the pendulum and the torque thereby created can be utilized to perform useful work.

### FIELD OF THE INVENTION

This invention relates to the type of engine in which, through alternate heating and cooling of an enclosed working fluid and gas, the fluid is subjected to varying pressure and displaced. Such displacement results in a weight imbalance and consequent torque, which can be utilized to create rotary motion or, as in the case of this invention, an oscillation. The invention also relates to devices which utilize the properties of a pendulum to enhance torque and regulate mechanisms.

In many under-developed areas of the world there is a great demand for simple inexpensive power sources using natural energy such as solar or wind to operate basic machines, especially pumps and grinding wheels. Vast arid regions exist that receive large amounts of solar radiation but have only sporadic rainfall and little easily accessible water, even though water is often present below the ground surface in the form of aquifers. The occupants' (often impoverished) quality of life would be greatly improved if the situation could be alleviated by the availability of basic, self-starting powered pumps requiring no fuel and little maintenance that would make such underground sources accessible. The small villages to be found in these regions generally comprise a number of huts clustered around a communal well or borehole, with numbers of people gathered throughout the day waiting their turn to operate the manual pump or windlass to fill containers which they then carry to their fields or huts. Another common feature is the sight of donkeys, blindfolded to try and avoid dizziness and disorientation, attached to poles which they haul in an endless circle to operate grinding wheels.

Wind and photovoltaic devices have been introduced in many areas, but have disadvantages. Wind pumps are prone to damage from the severe gusts which frequently occur in such regions, and require fairly strong and consistent winds to be viable. Photovoltaic mechanisms cannot work in darkness and involve an electrical phase that requires a degree of skilled maintenance and repair capability not readily found in such environments.

Ideally each village should have a pump supplying water to a header tank from which piped water could be gravity fed to faucets at strategic points; and a mechanical power source to operate grinding wheels.

As water is required mainly during daylight hours and early evening it is desirable that the pump should operate throughout the night, otherwise each morning—at a time of high demand—the tank is likely to be depleted. The invention presented herein can radically improve this situation as it is capable of operating in darkness. Because pumping will continue throughout the night a full header tank can be assured each morning, and the inhabitants of the villages would be relieved of much exhaustive physical labor. The invention is also suitable for powering grinding wheels and other types of machinery.

There have been numerous thermal inventions relating to oscillating or rotating devices based on an imbalance of working fluid caused by an increase in pressure, some of them being solar heated. Pendulums have been used for centuries in many varied devices for functions such as regulating clocks, boosting weak power inputs and controlling valves. Examples of both are given in the cited references. However it is submitted that the concept of combining a thermal oscillating device as presented herein with an attuned complementary pendulum in the manner depicted in the embodiments is unique to this invention.

### SUMMARY OF THE INVENTION

An object of the present invention is to provide a thermal pendular engine in which the two related parts, the rocking device and the attuned complementary pendulum, achieve an integrated synchronous oscillation.

A further object of the invention is to provide a thermal pendular engine in which the pendulum acquires momentum and enhances the engine's power output.

A further object of the invention is to provide a thermal pendular engine which in good conditions can achieve and maintain the maximum amplitude of oscillation.

A further object of the invention is to provide a thermal pendular engine which, even in conditions of small heat differentials, can maintain an oscillation without the need to attain extreme cyclic dispositions.

A further object of the invention is to provide a thermal pendular engine in which the planar orientation of its parts dispenses with the requirement for high internal operating pressures.

A further object of the invention is to provide a thermal pendular engine which can operate in both light and dark conditions.

The thermal pendular engine of the invention consists of a device and a complementary pendulum. The device comprises a pair of inclined containers, each firmly sealed and joined to opposite ends of a pipe which is pivotally mounted upon a horizontally extending axle that is housed in a shaft assembly. The containers and pipe are filled with an amount of liquid—preferably of low boiling point—that equates to approximately half the total volume of the two containers and the pipe, the remaining space being occupied by gas—usually the fluid's own saturated vapor. Both containers are constructed of a strong and effective heat conductive material such as steel or aluminum, and are designed to incorporate large area to volume ratios for respectively enhancing heat absorption and cooling; whereas the connecting pipe is preferably made of a poor conductive material such as plastic, with dimensions proportionate to those of the containers.

The pendulum and device can be rigidly fixed together and share the same axle or, preferably, the pendulum can be independently mounted, either on the device's axle or separately. The independently mounted pendulum can interact with the device by means of one or more thrusters, gearing or crank mechanism, and whether the pendulum is fixed or independent it is so designed that irrespective of the location of the working fluid, ancillary mechanisms and work load, the bob has sufficient weight to constantly dispose the device to a state of equilibrium in which the pipe slopes downward towards the hot leg end, thereby ensuring that the hot leg container is at any time either full, partially full or about to be replenished. The inclined plane of the hot leg container in relation to the pipe results in gas being trapped in its upper space which, upon heating, expands and forces liquid through the pipe to the cold leg.

Initially (when starting from stationary) as the fluid is forced up the pipe out of the hot leg container a level is reached where some gas escapes and an amount of liquid re-enters to repeat the cycle. Gradually, depending on prevailing conditions, this small alternating weight imbalance overcomes the static inertia of the pendulum causing it to oscillate. In ideal conditions—such as strong sunlight combined with the use of evaporative cooling—the device and the pendulum will oscillate synchronously with increasing amplitude until maximum gravitational potential energy and momentum are achieved by the bob as it reaches and swings between its cyclical zeniths. At this optimum amplitude each oscillation results in two tipping points, the first being when all the liquid has been expelled from the hot leg to the cold, the “primary power stroke”, followed by a total reversal when all the fluid runs back to the hot leg, “the secondary power stroke”.

The length of time taken between a primary and secondary power stroke depends largely upon the dimensions and design of the device and will remain constant irrespective of how varied is the time taken to achieve an amplitude where tipping occurs. The periodic time (the time taken to complete each swing from one side to the other and back again—an oscillation) of a pendulum is also constant irrespective of the weight of the bob or the amplitude of swing, it is solely dependent upon the length of the stem. Once the period of time between the primary and secondary power strokes is known then the following formula can be used to calculate the optimum length of the pendulum's stem: —

$$L = \frac{{t}^{2} \times g}{{π}^{2}}$$

where,
L=length of stem in meters
g=acceleration of gravity (9.807 m/s²)
t=time taken in seconds for all fluid in the cold leg to be completely transferred to the hot leg
πE=3.142

For practical purposes the nearly equal figures of gravity acceleration (g) and pi squared (π²) can be cancelled out, simplifying the equation to: —

L=t²

To overcome the necessity of fitting an impractically long pendulum, the velocity at which all the fluid returns to the hot leg between the two power strokes can be increased by fitting one or more ancillary pipes containing a non-return valve which only allows fluid to run to the hot leg. If the engine is being used to pump water to a header tank then to achieve a reasonable water pressure a height of about 6.25 meters is necessary. The supporting structure for the tank can also be used to mount a pendulum of the same length and facilitate the construction of an engine designed with an easily achievable 2.5 seconds (\sqrt{6.25}) for the evacuation of liquid from the cold to the hot leg.

Calculating the optimum weight of the bob is more complex. Slow running devices—such as old steammollers—often use an energy storing mechanism, a flywheel, both to store energy and act as the power take-off. In the present invention the same function is performed by the pendulum, and, like the flywheel, the power output depends largely on the momentum achieved. As momentum is the product of mass times velocity it follows that the bob should be as heavy as feasible and complete its arc of swing as speedily as possible. Velocity can be increased by extending the amplitude through which the bob swings and can be attained by the incorporation of mechanisms such as a rolling weight, gearing and utilization of the weight of water used for cooling—as later depicted in the description of the embodiments. The main requirement in calculating the optimum weight of the bob is that the turning moment of force of the pendulum must be greater than that of the side of the engine bearing a full container together with additional factors such as the rolling weight etc., to the extent that when static the engine will always assume an attitude with the pipe inclined slightly downward towards the hot leg container with the pendulum vertically aligned. Another factor that has to be considered is that if the bob is too heavy it could take an unacceptable length of time from start-up to reach a meaningful oscillation. In reality such determinations are greatly facilitated by the use of a pendulum with an adjustable stem, and a bob to and from which additional weights can be added or removed—if the bob consists of a container filled with sand then fine tuning is greatly simplified. Such facilities allow the parameters of a required model to be determined by experimentation.

As previously stated, the time between primary and secondary power strokes (the tipping points) remains constant, but the time taken to achieve these points varies. In the build up to the tipping points if the heat differential fluctuates considerably—such as the sun appearing and disappearing behind cloud if solar heated—then moments will occur when the synchronized interaction between the device and the pendulum will tend towards divergence which can cause great stress to the pendulum's stem. To cushion these occasional divergent forces the preferred embodiments comprise, at the most basic, flexible stems and pivots within rigid stems. At a more sophisticated level differential gearing can be used between the device and the pendulum.

### BRIEF DESCRIPTION OF THE DRAWINGS

FIG. 1 is a perspective view of the basic engine in a state of equilibrium, consisting of the hot and cold leg containers, connecting pipe, working fluid, thrusters, pendulum, shaft assembly, axle and support mounts.

FIG. 2 is a perspective view of the engine at a disposition where most liquid has been forced out of the hot leg container to the point where some gas has escaped, allowing an amount of liquid to re-enter; the resulting change in weight orientation has initiated oscillation of the pendulum.

FIG. 3 is a perspective view of the engine at its first extreme disposition—the primary power stroke—where all the fluid has been transferred to the cold leg.

FIG. 4 is a perspective view of the engine at its second extreme disposition—the secondary power stroke—where all the fluid has been transferred to the hot leg.

FIG. 5 shows an engine incorporating step-up gearing to increase the pendulum's amplitude.

FIG. 6 shows schematic detail of differential type gearing installed between the device and the pendulum to enhance synchronization.

FIG. 7 illustrates a pendulum's bob which can have individual weights—as depicted in the enlargement—added or taken from it.

FIG. 8 shows an embodiment utilizing solar heating, with means for shading and dispensing of coolant water to the cold leg, and incorporates a power take-off crank and a double ratchet and pinion mechanism—with enlargements—for converting reciprocating linear motion to one directional rotary motion.

FIG. 9 shows an engine incorporating a regenerator—with enlargement thereof—within the pipe.

FIG. 10 shows alternative means for mounting a pendulum with a fully flexible stem directly to the device's axle and activated with pinions.

FIG. 11 illustrates the pinions functioning during oscillation.

FIG. 12 shows a two part rigid pendulum attached directly to the device's axle, with a pivot joining the two parts of the stem.

FIG. 13 shows schematically an embodiment comprising two pipes, one of which contains a non-return valve—and enlargement thereof—that allows fluid to flow into, but not out of, the hot leg container.

FIG. 14 shows an embodiment comprising a rolling weight mechanism to boost the pendulum's amplitude

FIG. 15 illustrates an embodiment comprising a rolling weight and crank operated rod pump. Borehole or well water is pumped to a header tank with some being diverted to a small storage vessel located above the cold leg container and fitted with a release valve activated by a control mechanism. As the pipe has reached a lower inclination disposed toward the cold leg the weight has begun to roll thereto, while simultaneously the release valve has been opened allowing water to flow onto the enclosed area above the cold leg container.

FIG. 16 shows the engine at its first tipping point—the primary power stroke. The rolling weight is at its furthermost point along the cold leg, while the release valve is closed and the water that had been confined above the container flows out into a low level storage tank.

FIG. 17 depicts the engine in exactly the same disposition as FIG. 16 except that in this embodiment the water is further utilized. The water has been released from the cold leg and is flowing through a duct toward the hot leg where it flows into a vessel suspended from the hot leg container.

FIG. 18. Having attained its first tipping point—the primary power stroke—the cold leg is now ascending. The release valve is closed, the weight has rolled to its furthermost point along the hot leg, and the water-filled vessel suspended from the hot leg is descending.

FIG. 19. The engine has now attained its second tipping point—the secondary power stroke. The water vessel hung from the hot leg has reached its nadir and the guide rail has caused it to tip and empty its contents into the low level storage tank. Meanwhile the cold leg has attained its apogee, the release valve is open with water flowing onto the enclosed top of the cold leg container.

### DESCRIPTION OF THE EMBODIMENTS

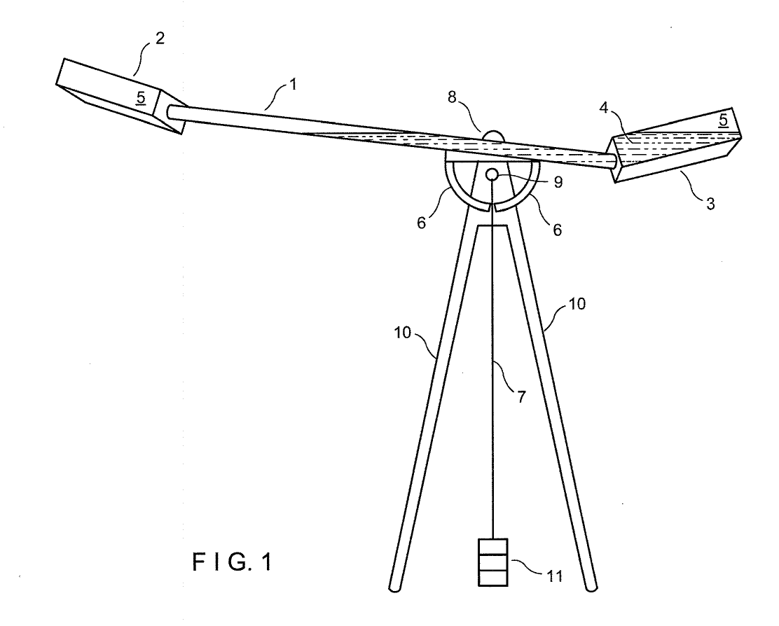

Referring to FIG. 1 the drawing illustrates the basic engine—the device and its complementary pendulum, attuned as earlier described—in a state of equilibrium. The device consists of a pipe 1 disposed in a rising inclination from a horizontal plane. At either end of the pipe 1 is attached a container 2, 3 each of which lies in a rising plane relevant to the pipe 1, the whole being sealed and filled with a quantity of fluid 4 that equates to about half the total volume of the containers 2, 3 and the pipe 1, the remaining space being filled with gas 5, preferably the liquid's own vapor. The fluid 4 can be water, but greater efficiency is achieved by using a low boiling point liquid such as methylene chloride or pentafluoropropane. An economical alternative is to use a suitable liquid such as pentane in combination with water. Pentane boils at 36° C., is less dense than water and insoluble in it, so although the bulk of the working fluid can be water, the floating pentane will provide the pressure. Securely fixed to the pipe 1 is a mechanism comprising two thrusters 6 which convey force to and from the pendulum's stem 7. The pipe 1 and thruster mechanism 6 are securely mounted upon a shaft assembly 8 within which is housed an axle (not shown) about which the device is free to swing. The pendulum can be mounted independently upon the same axle as the device, or, as illustrated in FIG. 1, be mounted upon its own axle 9, with the whole engine being supported by a structure 10 to which the respective axles are attached through bearings (not shown).

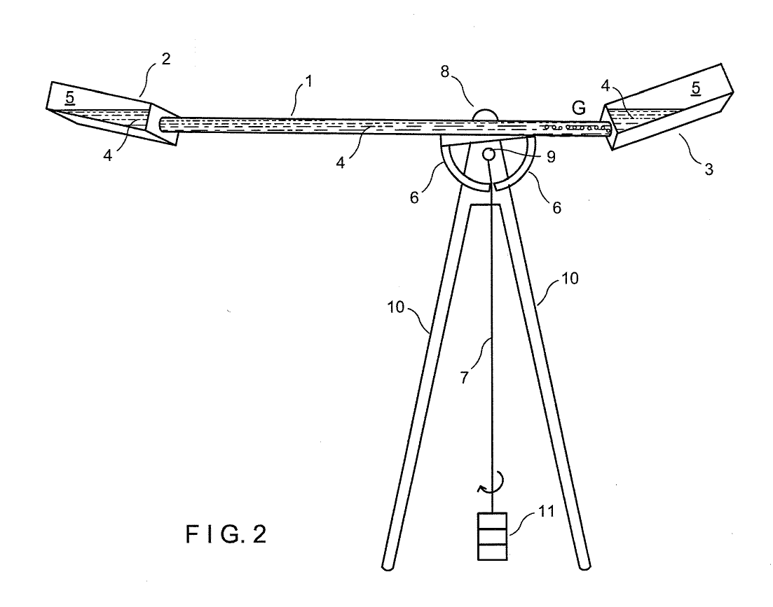

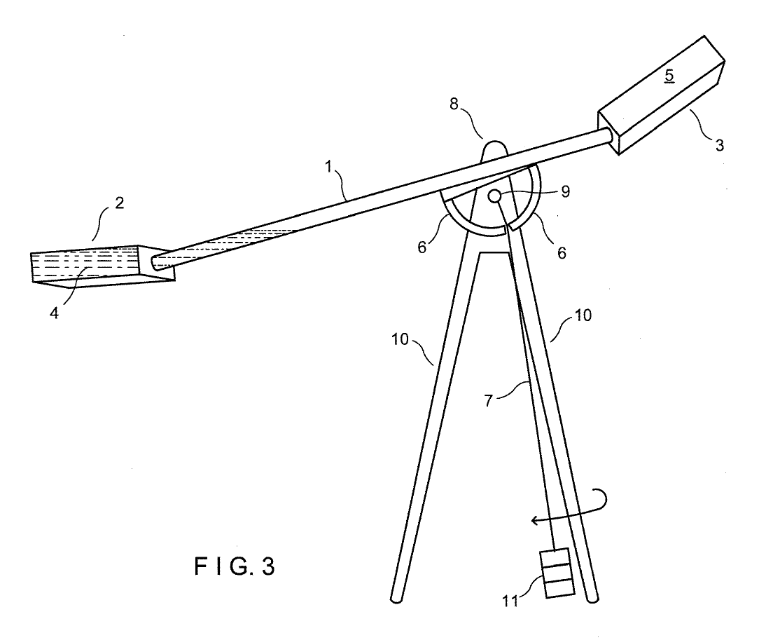

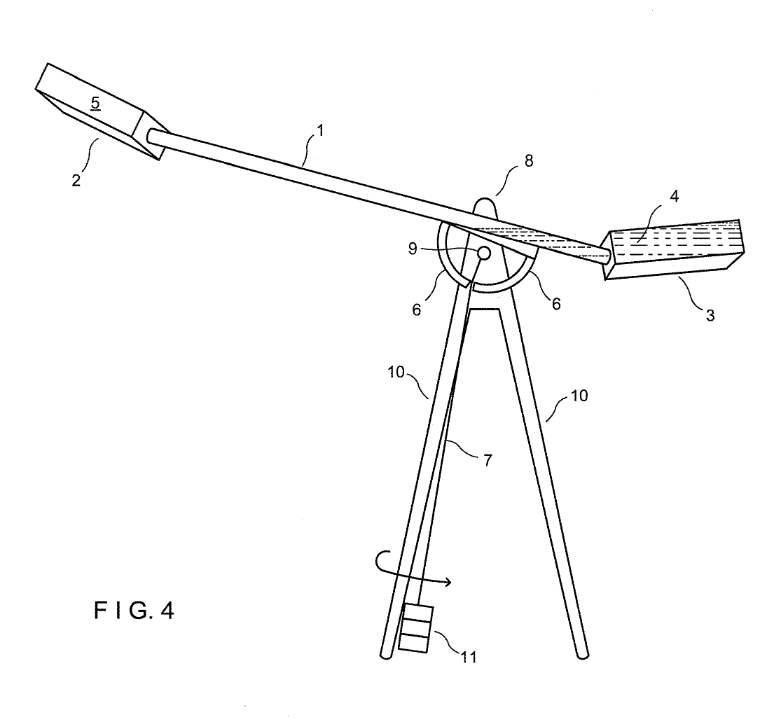

When the engine is in a state of static equilibrium as shown in FIG. 1 the inclination of the hot leg container 3 results in a pocket of gas 5 being trapped in the container's upper space. If heat is applied to the hot leg 3, or if the temperature of the cold leg 2 is less than that of the hot 3, then the trapped gas 5 will expand and exert pressure on the fluid 4 within the container 3 forcing some of it through the pipe 1 towards the cold leg 2. The fluid level in the hot leg container 3 will be forced down to a point where it reaches the rim of the pipe 1, as illustrated in FIG. 2, enabling some gas (as indicated at position G) to escape. The escaping gas results in a reduction of pressure within the container 3, thereby allowing some fluid 4 to re-enter and raise the fluid level. Once again the pocket of gas 5 is trapped and heated, causing increased pressure and expansion to repeat the cycle. This alternating displacement of fluid 4 with consequential weight alternation causes the pendulum to oscillate. Initially, when overcoming the static inertia of the pendulum's bob 11, oscillations are very small, but gradually the amplitude of the swings increases to the point where inclination of the pipe 1 is tilted from the horizontal downward towards the cold leg 2. At this stage all the fluid 4 runs into the cold leg 2 and the position is reached where the cold leg 2 swings to its lowest point—the primary power stroke—while the pendulum is at its highest as illustrated in FIG. 3. As it reverses direction at the apogee of its swing the weight of the pendulum's bob 11 with its acquired potential gravitational energy is sufficient to return the pipe 1 to and beyond a horizontal position. Fluid 4 from the inclined rising cold leg container 2 now flows with increasing velocity back to the hot leg 3 until the hot leg container 3 is full and swings down towards its nadir—the secondary power stroke—as shown in FIG. 4. Meanwhile the pendulum attains its alternate swing apogee, at which point the engine commences a further cycle. In good conditions if the fluid 4 boils almost immediately on entry to the hot leg container 3 a primary and secondary power stroke can be achieved with few intermediary oscillations, and in ideal circumstances can occur within each oscillation. However, meaningful work can be attained even in imperfect conditions so long as a sufficient heat differential can be maintained to cause an oscillation, even though cyclical extremes are not achieved.

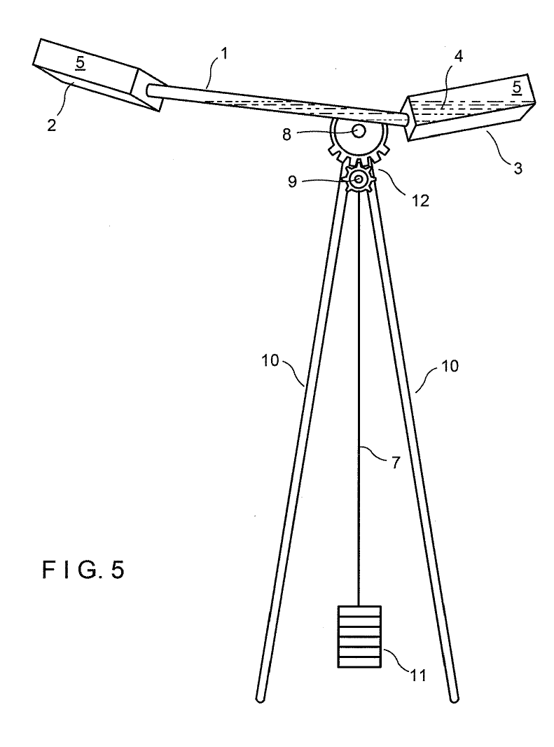

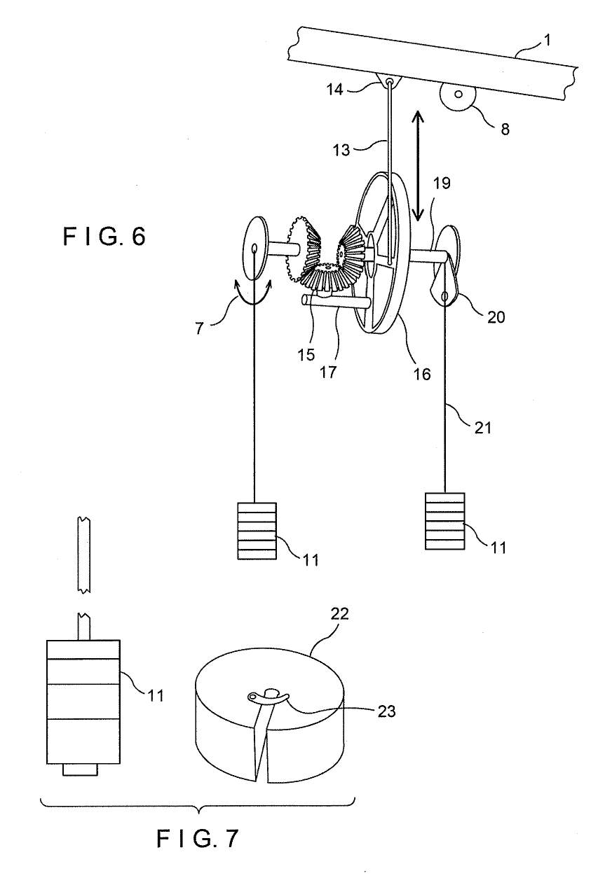

Attunement of the desired amplitudes and velocities of the device and the pendulum in relation to each other can be attained by installing a step-down or, as shown in FIG. 5 a step-up gearing mechanism 12 between the two. If the gearing is of a differential type as illustrated in FIG. 6 then a crankshaft 13 mounted on a bearing 14 attached to the device conveys force to and from a planet gear 15 via the ring wheel 16 and its carrier 17. One side-gear shaft 18 supports the pendulum while the other 19 is suitably weighted 20 to act as a clutch. Alternatively the weight 20 can be replaced by an additional pendulum 21 to perform the clutch function. A method of altering the weight of the pendulum's bob 11 is illustrated in FIG. 7 with detail of an individual weight 22 with holding clasp 23 enabling individual weights 22 to be easily added or removed.

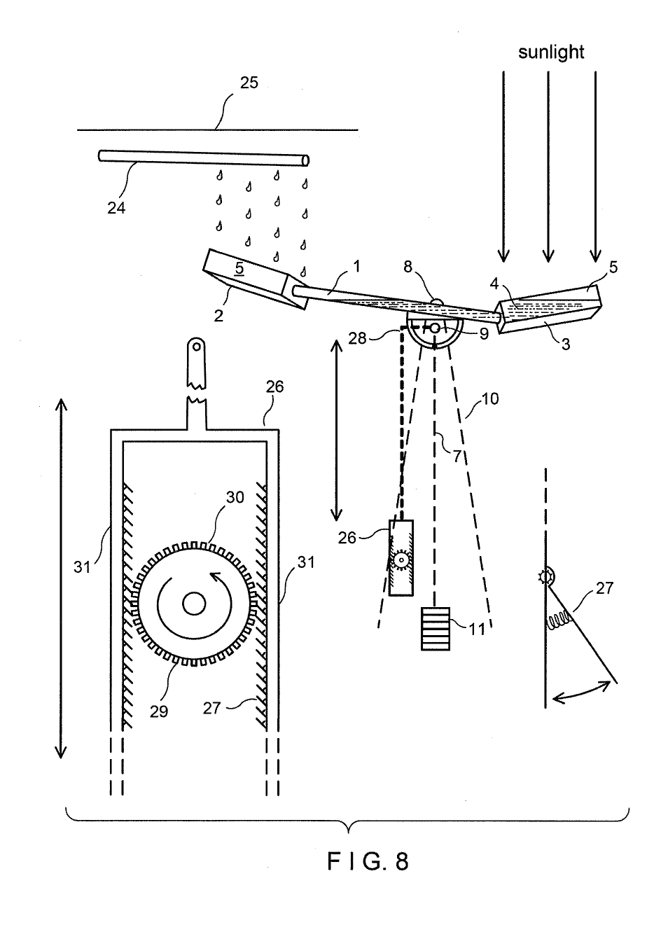

To ensure thermal efficiency the containers 2, 3 are configured to provide the maximum surface area for comparatively small volumes of fluid 4 such as—but not restricted to—the shallow rectangular containers 2, 3 as illustrated in the diagrams. They are constructed of a highly conductive material such as steel or aluminum, while the pipe 1 is made of a good insulating substance such as plastic. If water is being pumped or is freely available the cold leg container 2 should be coated with an absorbent material or have a dimpled surface to ensure a good wetted area onto which water can be dripped through a dispenser 24 to facilitate evaporative cooling, as shown in FIG. 8. If water is not available then vanes (not shown) can be fitted to the cold leg 2 to enhance air cooling, and whether or not the engine is solar heated, if situated where sunlight can impinge upon the cold leg 2, then a shade screen 25 should be provided as shown schematically in FIG. 8. The hot leg container 3 should be specially treated or coated with a black heat absorbing substance and, if solar heated, augmented by the fitting of reflectors and glass covering (not shown).

Also illustrated in FIG. 8 is a ratchet and pinion mechanism 26—with enlargement of the whole 26 and of a single pawl 27—operated by a crank 28 from the pendulum's axle 9. The mechanism provides a means of converting reciprocating linear motion into continuous one directional rotary motion, even if the linear power strokes are of irregular length. The mechanism can be as illustrated with the wheel 29 comprising the cogged section, or the configuration can be reversed with the cogs 30 being incorporated on the inner side of the prongs 31 and the pawls 27 on the wheel 29.

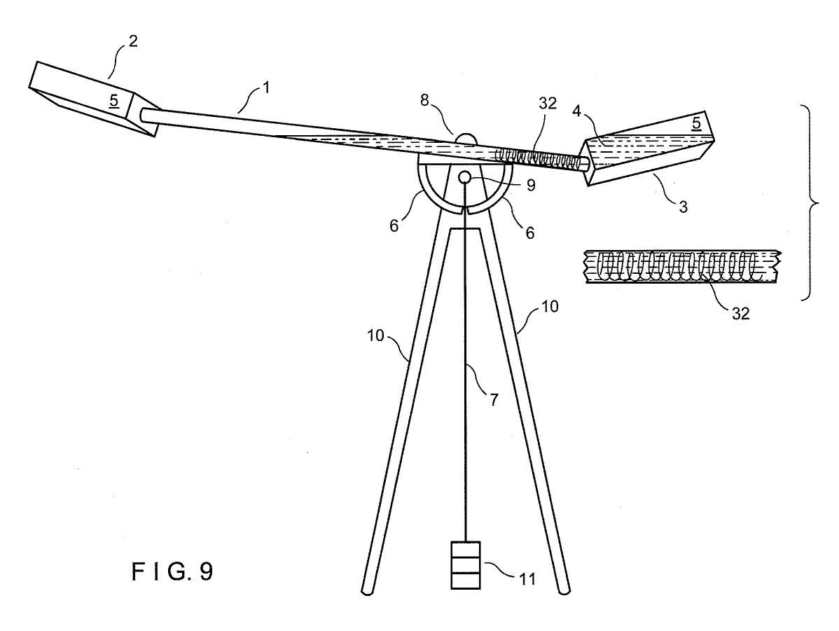

Thermal efficiency is improved by mounting the device on a shaft 8 situated closer to the hot leg end 3 than the cold 2, as illustrated in all the drawings. This configuration causes the cold leg container 3 to swing through a greater and speedier arc of travel thus enhancing air or evaporative cooling. Conversely the hot leg container 3 swings through a much smaller arc at a lower speed, thus conserving heat. It is this feature that enables the engine to function in darkness. When operating in arid regions with low humidity and high ambient temperatures efficient evaporative cooling ensures that sufficient thermal differential is maintained between the hot 3 and cold leg 2 to sustain oscillation. A regenerator 32 installed within the pipe 1 as shown in FIG. 9 also improves thermal efficiency: heated fluid gives up some of its heat to the regenerator 32 as it passes through on its way from the hot 3 to the cold leg 2, and then absorbs some of the heat back again on its return from the cold 2 to the hot leg 3.

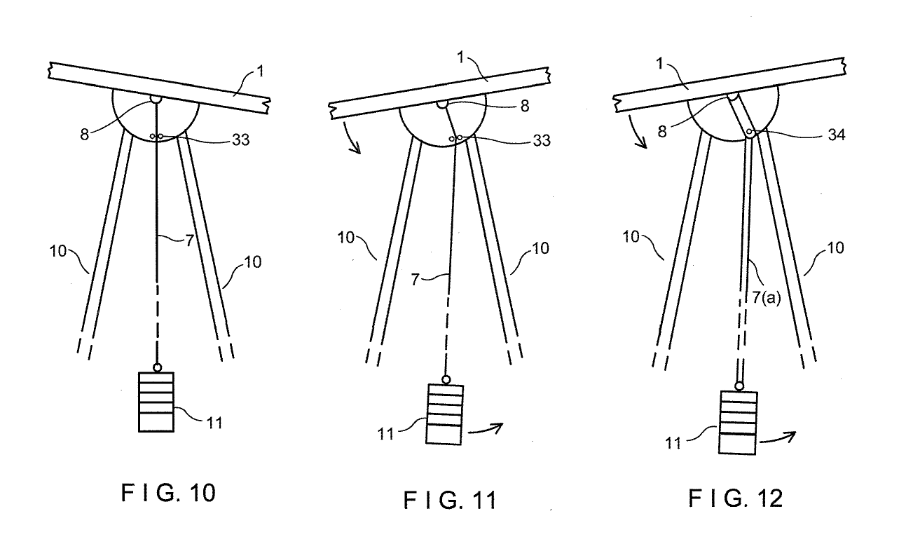

If the pendulum is fixed to the device and mounted on the same axle 8, then if the stem 7 is flexible as shown in FIG. 10 it can be activated by pinions 33 as shown in FIG. 11. The stem can be rigid 7(a), although to avoid stress it should be fitted with a pivot 34, as shown in FIG. 12. But pendulums operate more efficiently if the stem's weight can be kept to a minimum. Therefore in the preferred embodiments the stems 7 are fully flexible and made of a thin but strong material such as steel cable.

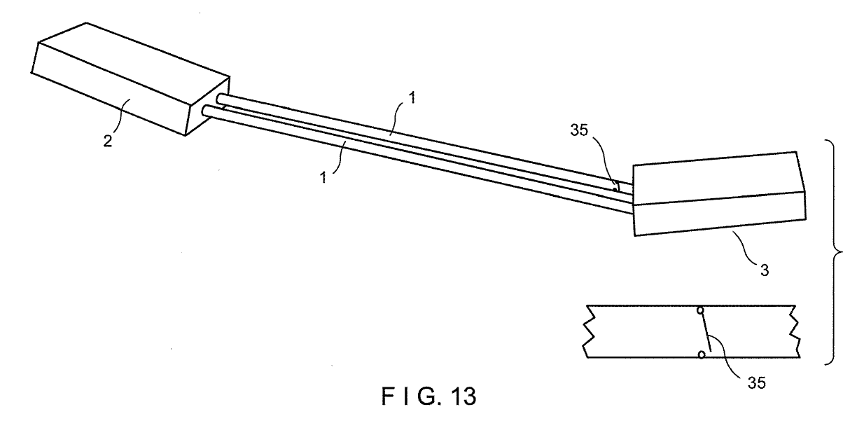

As previously stated the key to efficiency is to accurately attune the pendulum and ensure that maximum amplitude of swing is achieved by the bob 11 when the engine achieves primary and secondary power strokes. One of the critical factors in attaining maximum power is to ensure that the working fluid 4 flows rapidly from the cold leg 2 to the hot 3 between the primary and secondary power strokes. The time taken for this transfer can be considerably shortened by the installation of one or more additional pipes 1, each containing a non-return valve 35 which allows fluid to flow from the cold 2 to the hot leg 3 but not in the reverse direction, as illustrated schematically in FIG. 13.

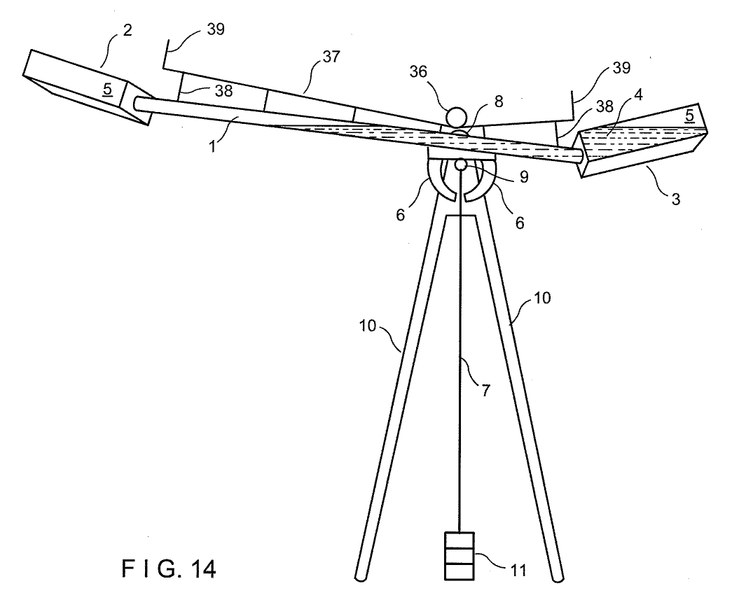

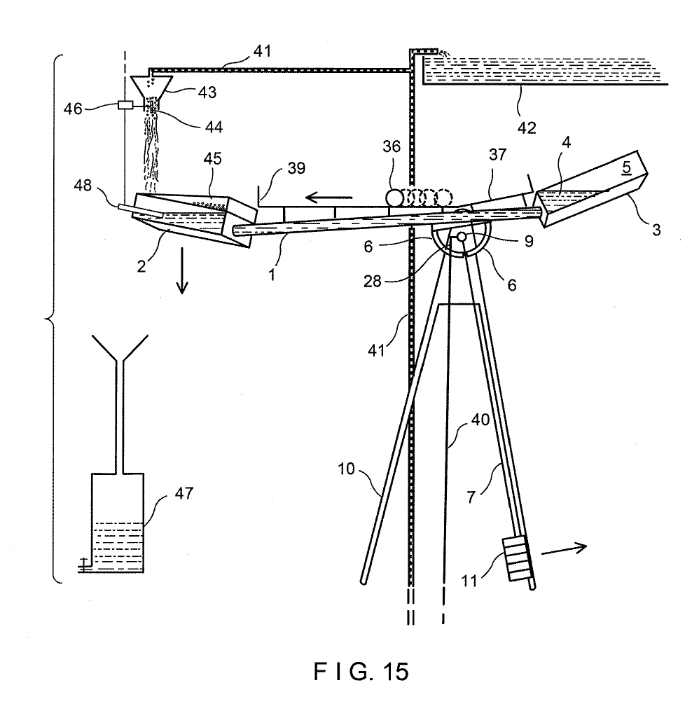

To boost the power strokes and increase torque a free running weight 36, in FIG. 14 portrayed as—but not restricted to—a sphere, is confined to a track 37 within which it can freely run either to the cold leg 2 or the hot leg 3 depending on the inclination of the pipe 1 to which the track 37 is fixed by supports 38. (In the diagram the track 37 is shown placed above the pipe 1, however it can be located otherwise, either to the side or underneath for example). The track 37—which can be of any desired feasible length—is inclined upward on either side from the shaft 8 where the rolling weight 36 rests when the engine is in equilibrium or if the oscillations are insufficient to cause the necessary slope of the track 37. Whenever the track 37 reaches an outer inclination that is below the horizontal the weight 36 will roll in that direction until restrained by the relative buffers 39, as shown in FIGS. 15-19.

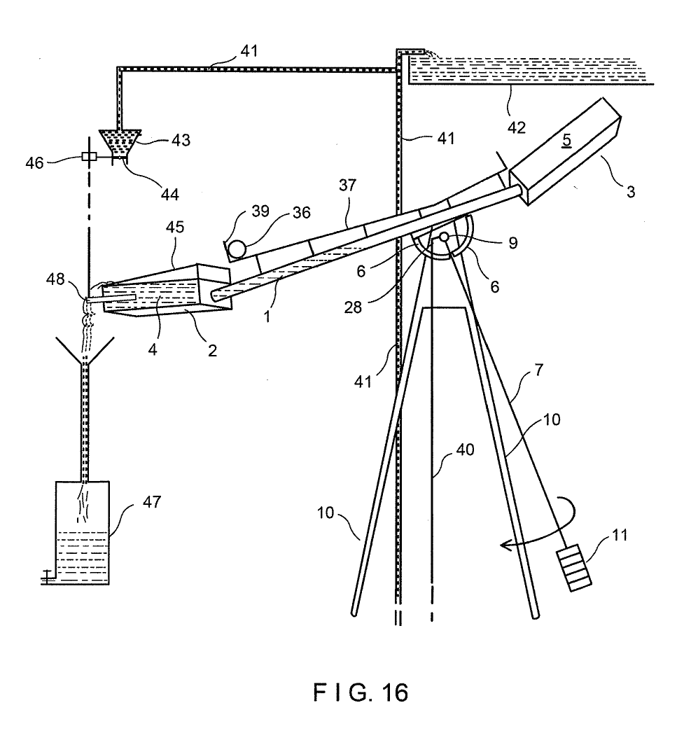

A further feature which boosts the primary power stroke is illustrated in FIG. 15 where the engine's crank 28 affixed to the pendulum's axle 9 is operating a rod pump 40 to extract water from a well or borehole and pump it through a pipe 41 into a header tank 42. A portion of the pumped water is diverted to a containment vessel 43 fitted with a valve 44 which opens to release the vessel's 43 contents onto the cold leg container 2 as it reaches its apogee. FIG. 15 shows water flowing onto the top of the cold leg container 2 with the vessel's 43 valve 44 still open as the cold leg container 2, having reached its highest point, is descending to complete the primary power stroke. During its descent the water above the cold leg container 2 is retained by sides 45 which skirt the container's 2 top surface. Before the cold leg container 2 reaches its nadir the control mechanism 46 closes the valve 44, while upon reaching its lowest point the water retained above the container 2 flows out into a low level storage tank 47 as illustrated in FIG. 16. The water that is retained above the cold leg container 2 during its descent—the primary power stroke—performs two functions: because it is in contact with the cold leg container's 2 surface it cools the container 2 and its contents and, with its added weight, increases torque. The valve control mechanism 46 can be activated by linkage 48 to any suitable part of the device, and is not restricted to the configuration as illustrated in FIGS. 15-19.

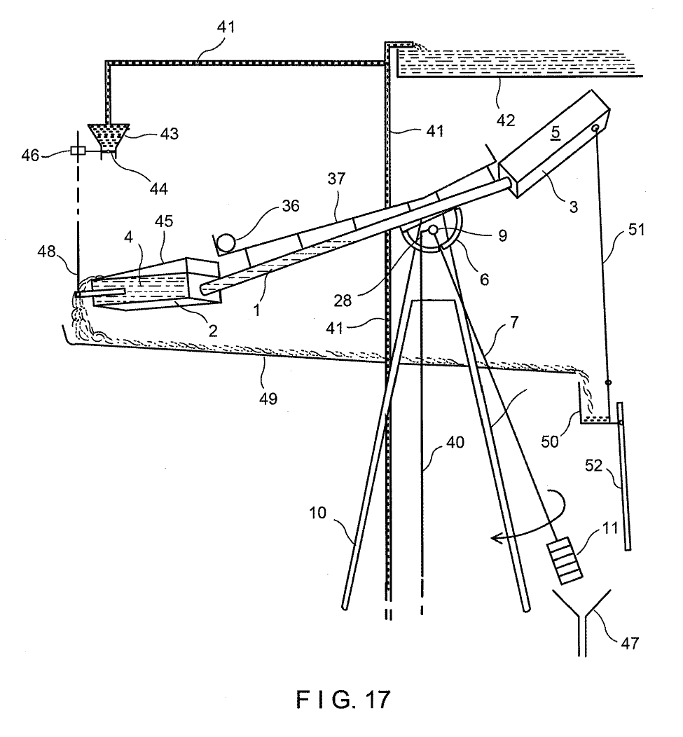

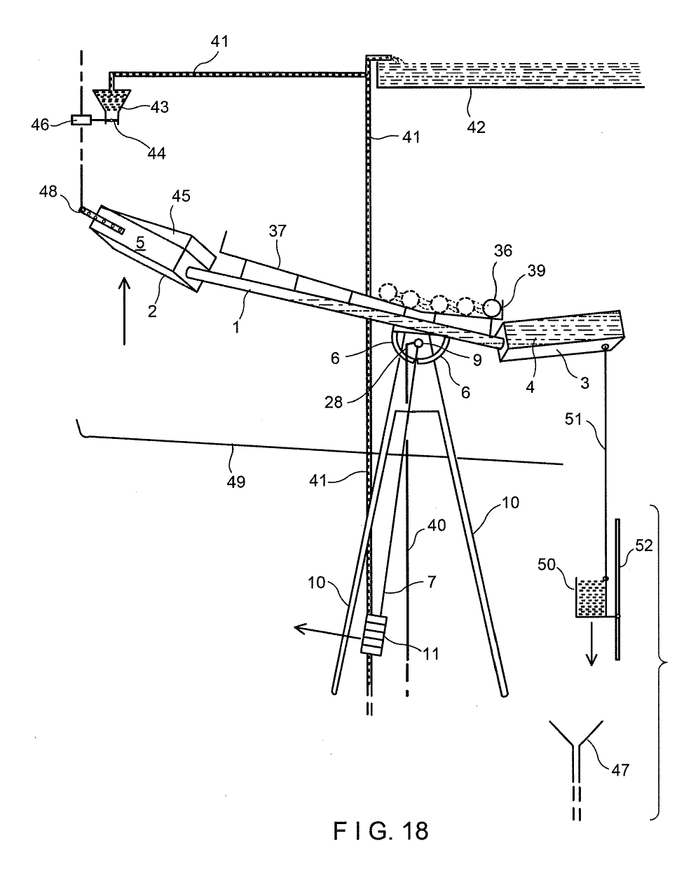

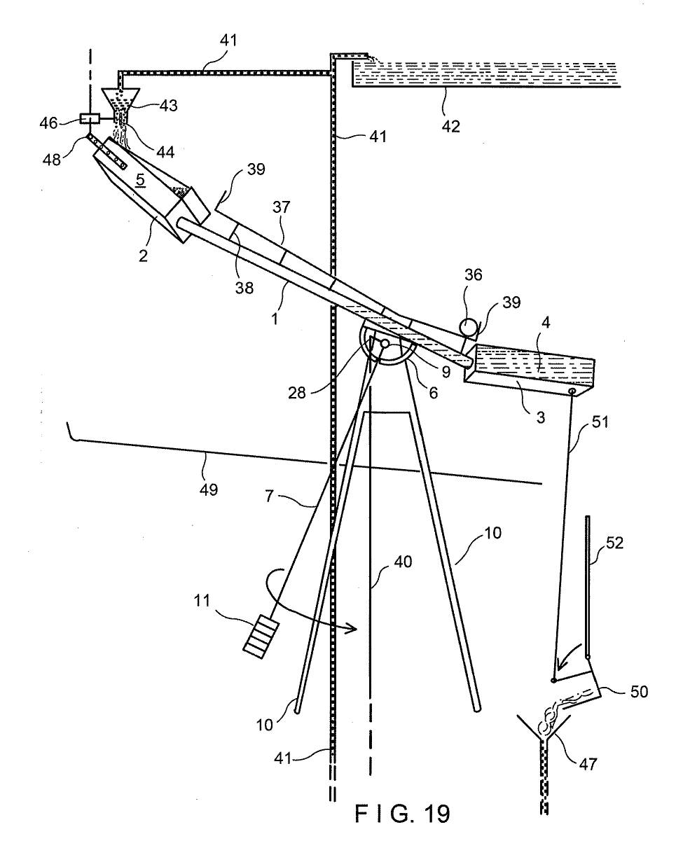

Further use can be made of the released water by subsequently utilizing it to also boost the secondary power stroke as illustrated in FIG. 17. Once the water flows out at the cold leg container's 2 nadir it is channeled through a duct 49 towards a point below the hot leg 3 where it flows into a vessel 50 suspended from the hot leg 3 by a rod or cable 51. As the hot leg 3 is at this stage descending the additional weight of the water boosts the torque of the secondary power stroke as shown in FIG. 18. At the nadir of the hot leg's 2 descent a guide rail 52 causes the vessel 50 to tip and empty its contents into the low level storage tank 47 as illustrated in FIG. 19. The cycle is then repeated.

### REFERENCES CITED

U.S. Patent Documents

| | | |
|---|---|---|
| 50,151 | September 1865 | Monson |
| 243,909 | July 1881 | Iske et al |
| 250,265 | November 1881 | Landis |
| 250,821 | December 1881 | Landis |
| 253,868 | February 1882 | Iske et al |
| 271,639 | February 1883 | Iske et al |
| 348,780 | September 1886 | Sattes |
| 847,229 | March 1907 | Branam |
| 1,911,456 | May 1933 | Lyon |
| 2,402,463 | June 1946 | Sullivan |
| 2,597,890 | May 1952 | Monk |
| 2,722,097 | November 1955 | Lefrand |
| 4,115,996 | September 1978 | Coy |
| 4,344,286 | August 1982 | Warner |
| 4,509,329 | April 1985 | Breston |
| 4,898,519 | February 1990 | Vanek |
| 6,012,959 | January 2000 | Blonder |
| 6,240,729 | June 2001 | Yoo et al |
| 20070137943 (App) | June 2007 | Duclos |
| 7,735,386 | June 2010 | Feltenberger |

Foreign Patent Documents

| | | | |
|---|---|---|---|
| 2,413,167 | October 2005 | GB | Willis et al |
| 2,418,034 | March 2006 | GB | Streitman |
| 2,442,585 | April 2008 | GB | Willis |

1. A thermal pendular engine comprising a device with at least one generally near horizontally inclined pipe mounted for oscillation upon a horizontally extending axis, said pipe having at least one container at either end, said container at one end being inclined to absorb heat from a heat source, said container at the other end being disposed to give up heat, said pipe and containers being partially filled with fluid and partially filled with gas; and said device comprising means for conveying oscillatory force to and from a complementary pendulum mounted and disposed relatively to said device.

2. A thermal pendular engine as claimed in claim 1 wherein said axis of said device is positioned in closer proximity to said container disposed to absorb heat.

3. A thermal pendular engine as claimed in claim 1 wherein said means for conveying said oscillatory force to and from said pendulum comprises thruster type projections.

4. A thermal pendular engine as claimed in claim 1 wherein said pendulum is mounted upon the same axle as that of said pipe.

5. A thermal pendular engine as claimed in claim 1 wherein said pendulum is mounted on a separate axle to that of said pipe.

6. A thermal pendular engine as claimed in claim 1 wherein said pendulum's stem is fully or partially flexible.

7. A thermal pendular engine as, claimed in claim 1 wherein said pendulum's stem is fully or partially rigid.

8. A thermal pendular engine as claimed in claim 7 wherein said pendulum's stem contains one or more pivots.

9. A thermal pendular engine as claimed in claim 1 wherein one or more of said pipes incorporate at least one non-return valve.

10. A thermal pendular engine as claimed in claim 1 wherein one or more of said pipes incorporate at least one regenerator.

11. (canceled)

12. A thermal pendular engine as claimed in claim 1 wherein said gas or part of said gas is the vapor of said fluid.

13. A thermal pendular engine as claimed in claim 1 wherein said fluid has a boiling point below that of water.

14. A thermal pendular engine as claimed in claim 1 wherein said fluid is a combination of two or more liquids.

15. A thermal pendular engine as claimed in claim 1 wherein said container disposed to absorb heat is exposed to sunlight as said heat source.

16. (canceled)

17. (canceled)

18. A thermal pendular engine as claimed in claim 1 comprising gear mechanism between said device and said pendulum.

19. A thermal pendular engine as claimed in claim 18 wherein said gearing mechanism is a differential type gear comprising a counterweight.

20. (canceled)

21. A thermal pendular engine as claimed in claim 1 comprising a ratchet and pinion mechanism for converting oscillatory to single directional rotary motion.

22. A thermal pendular engine as claimed in claim 1 comprising means for enhancing torque and oscillation by inclusion of a rolling weight mechanism.

23. A thermal pendular engine as claimed in claim 1 comprising means for enhancing oscillation and cooling by the release of water onto the top of said container disposed to give up heat or into a vessel fixed adjacently to said container.

24. A thermal pendular engine as claimed in claim 23 wherein said water is subsequently conveyed in a duct fixed adjacently to said pipe towards and into a vessel fixed relatively to said container disposed to absorb heat.
